(19) United States
(12) Patent Application Publication
(10) Pub. No.: US 2008/0017425 A1
(43) Pub. Date: Jan. 24, 2008

(54) Process For Operating A Brake Actuation Unit Of A Motor Vehicle Brake System

(75) Inventors: Christian Albrich von Albrichsfeld, Darmstadt (DE); Gunther Buschmann, Idstein (DE); Manfred Ruffer, Sulzbach (DE); Lothar Kienle, Lampertheim (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG & OHG

(21) Appl. No.: 11/578,870

(22) PCT Filed: Apr. 19, 2005
(86) PCT No.: PCT/EP05/51717

§ 371 Date: Jun. 18, 2007

(30) Foreign Application Priority Data
Apr. 20, 2004 (DE) 102004019194.1

(51) Int. Cl. B60T 15/16

(52) U.S. Cl. 180/65.2; 303/13; 303/20; 701/70; 903/902

(57) ABSTRACT

Disclosed is a process for operating a brake actuation unit of a motor vehicle brake system of the ‘brake-by-wire’ type. The brake system has a brake booster, a master brake cylinder, and a pedal travel which interacts with the brake pedal and due to a resetting force acting on the brake pedal can be simulated in the ‘brake-by-wire’ operating mode independently of an actuation of the brake booster, and which can be enabled in the ‘brake-by-wire’ operating mode when the force-transmitting connection between the brake pedal and the brake booster is decoupled and can be disabled outside the ‘brake-by-wire’ operating mode. In order to minimize a constructively predetermined axial slot ‘a’ between the end of a piston rod 10 coupled to the brake pedal 1 and a control piston 11 of the control valve 9 of the brake booster 3 in regenerative brake operations, while a predetermined actuating travel of the brake pedal (1) is covered, where actuation of the brake booster (3) is not intended, software-related technical measures are performed immediately before a force-transmitting connection between the brake pedal (1) and the brake booster (3) occurs, which prevent the force-transmitting connection between the brake pedal (1) and the brake booster (3).

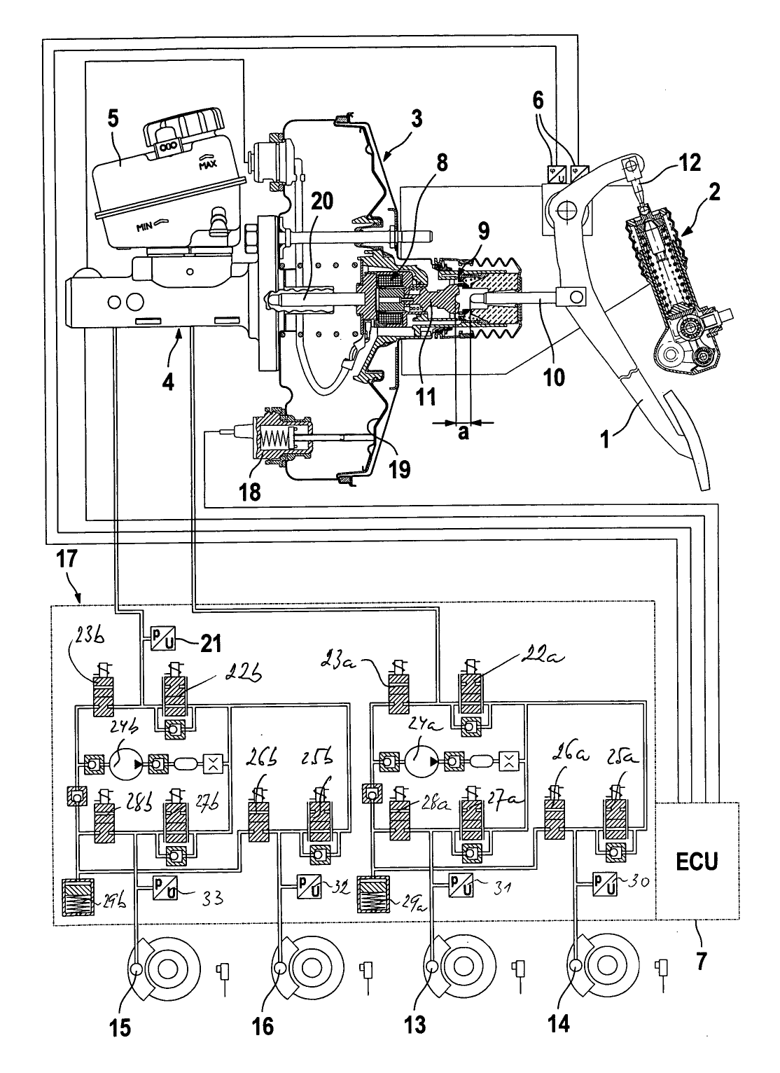

### BACKGROUND OF THE INVENTION

The present invention relates to a process for operating a brake actuation unit of a motor vehicle brake system of the ‘brake-by-wire’ type comprising
a) a brake booster which is operable in response to the driver's wish both by means of a brake pedal and by means of an electronic control unit, and a means is provided to decouple a force-transmitting connection between the brake pedal and the brake booster in the ‘brake-by-wire’ operating mode,
b) a master brake cylinder connected downstream of the brake booster,
c) a means to detect a deceleration request of the driver, and
d) a pedal travel simulator which interacts with the brake pedal and due to which a resetting force acting on the brake pedal can be simulated in the ‘brake-by-wire’ operating mode independently of an actuation of the brake booster, and which can be enabled in the ‘brake-by-wire’ operating mode when the force-transmitting connection between the brake pedal and the brake booster is decoupled and can be disabled outside the ‘brake-by-wire’ operating mode.

An actuation unit of this type is disclosed in international patent application WO 2005/014351. Brake actuation units of this type are especially well suited for brake systems being employed in motor vehicles, in which so-called regenerative brake operations are carried out. Vehicles with a hybrid drive or electric drive can be referred to as an example, in which defined deceleration values are achieved by the electric motor working on generator gas. In this arrangement, the axial slot, which is provided between the end of a piston rod coupled to the brake pedal and the control piston of the pneumatic control valve, is used to decouple the force-transmitting connection between the brake pedal and the brake booster in the ‘brake-by-wire’ operating mode. This slot represents a lost travel that can be felt at the brake pedal, in particular upon failure of the electromechanical actuation of the control valve, when the actuation unit operates in the so-called ‘fallback mode’. It is therefore suitable to dimension the above-mentioned slot as small as possible.

When employing a brake actuation unit of this type to carry out regenerative brake operations, it seems more favorable to use a larger slot because it represents the area of the actuating travel in which the electric motor develops its braking effect. Further, irritations of the pedal feeling are avoided during ABS brake operations. However, this request is in contradiction to the demand of realizing a minimum slot as referred to hereinabove.

In view of the above, an object of the invention is to disclose a method for the operation of a brake actuation unit of the type mentioned hereinabove, which allows minimizing the constructively predetermined axial slot in vehicles able to carry out regenerative brake operations.

### SUMMARY OF THE INVENTION

According to the invention, this object is achieved in that, while a predetermined actuating travel of the brake pedal is covered, where actuation of the brake booster is not intended, software-related technical measures are performed immediately before a force-transmitting connection between the brake pedal and the brake booster occurs, which prevent the force-transmitting connection between the brake pedal and the brake booster.

To render the idea of the invention more precise, it is arranged for that the electronic control unit actuates the brake booster in such a fashion that all lost travels in the master brake cylinder are eliminated.

In another favorable improvement of the process mentioned hereinabove, the electronic control unit actuates the brake booster in such a manner that all clearances in the wheel brakes connected to the master brake cylinder are eliminated.

In still another favorable improvement of the process of the invention, the electronic control unit actuates the brake booster in such a manner that a defined pressure fluid volume is discharged into low-pressure accumulators, which can be connected to the wheel brakes by way of outlet valves.

Another especially favorable feature of the process of the invention, which is implemented in a motor vehicle equipped with an electric driving motor, involves that clearances in wheel brakes associated with one axle of the motor vehicle are eliminated, while braking on the other axle is executed by the electric driving motor.

It is especially expedient in this arrangement that the software-related technical measures are carried out when an axial slot falls below a predetermined minimum value, which slot is provided between a piston rod coupled to the brake pedal and a control piston of a pneumatic control valve of the brake booster.

The minimum value is preferably determined from the actuating travel of the piston rod and the travel that is covered upon actuation of the brake booster by the booster's output member that actuates the master brake cylinder.

Besides, the software-related technical measures can be performed in response to the actuating speed of the piston rod.

Further features and advantages of the invention will be explained in detail in the following description making reference to the accompanying drawing.

### BRIEF DESCRIPTION OF THE DRAWING

The FIGURE is a schematic view of a brake system.

### DETAILED DESCRIPTION OF THE DRAWING

The brake system shown in the drawing and intended for the actuation of a motor vehicle brake system of the ‘brake-by-wire’ type essentially comprises a brake booster, preferably a vacuum brake booster 3, a master brake cylinder connected downstream of the brake booster 3, preferably a tandem master cylinder 4, to the pressure chambers (not shown) of which wheel brakes 13, 14, 15, 16 of a motor vehicle are connected by the intermediary of a hydraulic control unit 17, a pressure fluid tank 5 associated with the master brake cylinder 4, a brake pedal 1 for actuation of the brake booster 3 by the driver, a pedal travel simulator 2 which cooperates with the brake pedal 1, in particular in the ‘brake-by-wire’ operating mode, and imparts the customary brake pedal feeling to the driver, at least one sensor device 6 for sensing a driver's deceleration request or the actuating travel of the brake pedal 1, as well as an electronic control unit 7, the output signals of which enable, among others, actuation of an electromagnet 8 associated with the brake booster 3 and rendering it possible to actuate a pneumatic control valve 9 independently of the driver's wish, the said control valve controlling the supply of air to the brake booster 3. As will be explained in detail in the following description, the electronic control unit 7 comprises a control circuit for controlling a characteristic quantity of the brake booster 3, preferably the travel covered by the output member 20 of the brake booster 3, and/or for controlling the hydraulic pressure that prevails in the system.

An axial slot ‘a’ provided between the end of a piston rod 10 coupled to the brake pedal 1 and a control piston 11 of the above-mentioned control valve 9 ensures decoupling the force-transmitting connection between the brake pedal 1 and the brake booster 3 in the ‘brake-by-wire’ operating mode. A travel sensor 18 is used to sense the travel of a movable wall 19 that generates the boosting power of the brake booster 3, or the travel of the above-mentioned output member 20 of the brake booster 3, which transmits its output force onto a non-illustrated first piston of the master brake cylinder 4. In addition, a pressure sensor 21 is integrated in the hydraulic control unit 17 and senses the hydraulic inlet pressure that prevails in the system.

The pedal travel simulator 2 by which, as has been mentioned above, a resetting force acting on the brake pedal in the ‘brake-by-wire’ operating mode can be simulated irrespective of an actuation of the brake booster 3, is designed in such a fashion that it can be enabled in the ‘brake-by-wire’ operating mode when the force-transmitting connection between the brake pedal 1 and the brake booster 3 is decoupled, and can be disabled outside the ‘brake-by-wire’ operating mode. The pedal travel simulator 2 is actuated by means of an actuating member 12 articulated at the brake pedal 1.

Further, it can be taken from the drawing that the hydraulic regulating and control unit (HCU) 17 includes all hydraulic and electrohydraulic components required to perform brake pressure control operations. Among these are per brake circuit: each one separating valve 22a, b, one electric change-over valve 23a, b, a hydraulic return pump 24a, b, in each case two electrically actuatable pressure control valves or inlet and outlet valves 25a, b, 26a, b, 27a, b, and 28a, b for the selective adjustment of the brake pressure at the wheel brakes 13 to 16, each one low-pressure accumulator 29a, b as well as pressure sensors 30, 33 associated with the wheel brakes 13 to 16.

As has been referred to hereinabove, the process of the invention is used for the most optimal dimensioning or minimizing of the axial slot ‘a’, in particular when performing regenerative brake operations, in which part of the braking effect is provided by the electric motor working on generator gas. It is desired in partial braking operations of this type that a long actuating travel of the brake pedal 1 is allowed, without the brake booster 3 being actuated or without the vehicle being decelerated by the hydraulically operable friction brakes. Thus, the axial slot ‘a’ can be rated only to ensure a low deceleration, e.g. 0.1 g. When this slot is almost overcome during a brake operation, the electromagnet 8 will be actuated immediately before force transmission between the piston rod 10 and the control piston 11 of the control valve 9 occurs in such a fashion that the two pistons of the master brake cylinder 4 are displaced so far due to the advancing movement of the movable wall 19 of the brake booster 3 or its output member 20 that any lost travels existing in the master brake cylinder 4, e.g. the closing travels of available central valves, are eliminated. This process causes an increase of the slot ‘a’, however, no pressure develops in the wheel brakes 13 to 16. When the slot will now be almost overcome again due to stronger depression of the brake pedal 1, a more intense actuation of the brake booster 3 will eliminate the clearances of the wheel brakes 13 to 16. This will, in turn, lead to further increase of the slot ‘a’, causing the pressure in the wheel brakes 13 to 16 to rise only to a negligible extent. When slot ‘a’ will then be almost overcome again due to a still more intense application of the brake pedal 1, while it is still possible to generate the desired deceleration in a ‘regenerative’ fashion, the brake booster 3 will be actuated still further in a last step, and pressure buildup in the wheel brakes 13 to 16 is prevented by discharge of the pressure fluid into the above-mentioned low-pressure accumulators 29a, b.

Other modifications are, of course, also feasible within the scope of the invention. Thus, the software-related technical measures can be taken in addition, depending on the driving state or the possible deceleration provided by the driving track.

1-8. (canceled)

9. A motor vehicle brake system of a ‘brake-by-wire’ type comprising:
a brake pedal which is moveable by a driver;
an electronic control unit;
a brake booster;
a device, wherein the brake booster is operable in response to a driver's wish both by the brake pedal and by the an electronic control unit, and the device is provided to decouple a force-transmitting connection between the brake pedal and the brake booster in the ‘brake-by-wire’ operating mode;
a master brake cylinder connected downstream of the brake booster;
a detector to detect a deceleration request of the driver; and
a pedal travel simulator which interacts with the brake pedal and due to which a resetting force acting on the brake pedal can be simulated in the ‘brake-by-wire’ operating mode independently of an actuation of the brake booster, and which can be enabled in the ‘brake-by-wire’ operating mode when the force-transmitting connection between the brake pedal and the brake booster is decoupled and can be disabled outside the ‘brake-by-wire’ operating mode, wherein while a predetermined actuating travel of the brake pedal (1) is covered, where actuation of the brake booster (3) is not intended, software-related technical measures are performed immediately before a force-transmitting connection between the brake pedal (1) and the brake booster (3) occurs, which prevent the force-transmitting connection between the brake pedal (1) and the brake booster (3).

10. A system according to claim 9, wherein an electronic control unit (7) actuates the brake booster (3) in such a fashion that all lost travels in the master brake cylinder (4) are eliminated.

11. A system according to claim 10, wherein the electronic control unit (7) actuates the brake booster (3) in such a manner that all clearances in wheel brakes (13 to 16) connected to the master brake cylinder (4) are eliminated.

12. A system according to claim 10, wherein the electronic control unit (7) actuates the brake booster (3) in such a manner that a defined pressure fluid volume is discharged into low-pressure accumulators (29a, b), which can be connected to wheel brakes (13 to 16) by way of outlet valves (26a, b; 28a, b).

13. A system according to claim 10, wherein the system is implemented in a motor vehicle equipped with an electric driving motor and clearances in wheel brakes associated with one axle of the motor vehicle are eliminated, while braking on the other axle is executed by the electric driving motor.

14. A system according to claim 9, wherein the software-related technical measures are carried out when an axial slot (a) falls below a predetermined minimum value, wherein the slot is provided between a piston rod (10) coupled to the brake pedal (1) and a control piston (11) of a pneumatic control valve (9) of the brake booster (3).

15. A system according to claim 14, wherein a minimum value is determined from the actuating travel of the piston rod (10) and the travel that is covered upon actuation of the brake booster (3) by the booster's output member (20) that actuates the master brake cylinder (4).

16. A system according to claim 14, wherein the software-related technical measures are performed in response to the actuating speed of the piston rod (10).
